(19) United States
(12) Patent Application Publication
(10) Pub. No.: US 2007/0054107 A1
(43) Pub. Date: Mar. 8, 2007

(54) Moulded components

(75) Inventors: Ernest Kenneth Hammond, Middlewich (GB); Nicholas Guy Clarke, Nantwich (GB)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: POLYMER DOORS LIMITED, Crewe, Cheshire (GB)

(21) Appl. No.: 10/559,136

(22) PCT Filed: May 30, 2003
(86) PCT No.: PCT/GB03/02398

§ 371 Date: Apr. 10, 2006

(30) Foreign Application Priority Data
May 30, 2002 (GB) 02125458

(51) Int. Cl. B29C 45/14; A63B 37/00; B32B 3/26

(52) U.S. Cl. 428/304.4; 264/279; 264/279.1

(57) ABSTRACT

A method of making a moulded component (for example a door) comprises placing a core comprising at least one slab of foam material into one half of a mould with LPSMC, closing the mould and applying pressure and heat to render the LPSMC fluid to at least partially envelop the core and thereby produce a LPSMC coated component, wherein the core has at least one cavity which extends across the width thereof and which has at least a portion which is inboard of the intended outer edge of the component, whereby causing the LPSMC to flow into said at least one cavity to form a bridge between the sides of the so-formed component. The foam material may have a portion with a density in excess of 250 kgm⁻³. The core may comprise two slabs of material with a density in excess of 250 kgm⁻³ either side of a lower-density core material.

This invention relates to methods of making a moulded component and to moulded components made by said methods. Specifically, but not exclusively, the moulded component may be formed as a door, say, an exterior or external door.

It is well known that resin transfer moulding (RTM) techniques can be used to form a panel. In RTM, a liquid resin is transferred by pressure from a vessel into a mould which is held at a constant temperature. If the mould contains a core and reinforcement surrounding the core, the resin will flow over and around the core and through the reinforcement, thereby enveloping the core. Once the resin is cured, a resin-covered core is produced. A suitable resin is uncured polyester which may be dissolved in a solvent such as styrene. Suitable core materials are polyurethane or phenolic foams. The reinforcement may be a plurality of glass or natural fibres, such as in the form of a mat.

In our British patent application no. 0018976.1, published as GB 2365378 A (Agent's Ref: P02881GB), we propose the manufacture of a panel using resin transfer moulding and the above-identified materials. The core material is covered in a sleeve of reinforcing material, such as a glass-fibre mat prior to placing it in the mould. The reinforcing material not only provides reinforcement to the finished product but also aids the adhesion of the resin to the core. In one specific embodiment, we mention the manufacture of a door for external use.

Sheet moulding compounds (SMCs) are thermoset plastics materials which contain discrete fibrous reinforcement. They are provided in sheet form and may be placed into closed, heated moulds to form a moulded product. Conventionally, SMCs are moulded at high temperatures (typically 135 to 155° C., although the temperature can be as high as 200° C.) and pressures (1.013 to 10.132 MPa). As the SMC melts to adopt the shape of the mould, the reinforcing fibres are carried with the resin and are subsequently homogeneously distributed throughout the moulded product. A typical SMC compound is described in U.S. Pat. No. 5,075,393.

As the SMC is formed from a thermoset resin, the resulting moulded product is, inter alia, hard-wearing, resistant to environmental degradation and can be made fire resistant by the inclusion of a fire retardant additive such as aluminium trihydrate, calcium carbonate, barium sulphate, kaolin, silicon dioxide and the like. Further, the SMC can be coloured by the inclusion of a suitable pigment.

SMCs have been used to manufacture such products as seats for public transport vehicles, tables, wall panels and so on. Each of these products have been formed using a closed mould technique, as described above. Clearly, by manufacturing an article from SMC, the bulk properties of the article so-produced, such as density, are typically those of the SMC.

It is a desideratum to produce a moulded component in, for example a complex shape, which has a core of one material and which is covered with moulded SMC. Such a method would allow one to more carefully select and control the bulk properties of the finished product, such as overall weight, whilst ensuring that the core material is protected from, say, environmental degradation. Clearly, having a core of a material less dense than SMC, the core volume of SMC is displaced from the so-formed product, compared with a product made exclusively from SMC. As the resins are relatively heavy and expensive, there will be a commensurate reduction in both weight and price of such a product.

U.S. Pat. No. 5,634,508 discloses a storm door fabricated by pre-moulding SMC to form two facing skins of a door. Each facing skin of the door is provided with formations which, when the two skin halves are pushed together, engage one another to ensure accurate location of the two skins with respect to one another. The skin halves may be adhered together by a foam material which is located in a plurality of discrete cavities between the skins. The function of the foam is to adhere the two SMC panels together, it does not provide the so-formed door with any structural rigidity. Moreover, the foam, when set, provides discrete cells between around the periphery of the area between the skins of the so-formed door only.

Because of the high temperatures and pressures required to mould SMCs, it has been very difficult to use an SMC to cover core materials in a single moulding step because the core materials will collapse or become heat damaged during the closed-moulding operation.

Recently, advances have been made in SMC technology and low temperature and pressure SMCs (LPSMC) are available, by which we mean an SMC which is mouldable at pressures equal to or less than 3.034 MPa (30 bar). WO 99/50341 discloses a LPSMC which can be moulded at a temperature of less than 70° C. and at pressures of less than 1.013 MPa. The application states that the SMC can be moulded at pressures as low as 0.1 to 0.2 MPa.

WO 99/50341 discloses the use of SMC to form a ‘sandwich element’ to provide the walls of temperature controlled containers. The sandwich element is formed from a flat sheet of low-density foam material which is covered with a surface fleece. The fleece-covered foam material is placed in a mould with strips of LPSMC and the mould is subjected to a pressure of 1 to 2 bar at, say, 60° C. The so-formed sandwich elements must be lightweight and self-supporting to ensure that any vehicle on which they are located can have a highest possible load of goods. The use of low-density foams means that only flat sheets or relatively ‘uncomplex’ shapes can be produced. Furthermore, such panels are unsuitable for use as doors because they lack the necessary mechanical strength and rigidity.

In our British patent application no. 0200498.8, published as GB 2371075 A (Agent's Ref: P03408GB), we disclose a door fabricated by forming a frame of pultruded lengths and mounting those lengths about a core of structural density foam material. Skins are adhered to the so-formed substrate to provide a door. The skins may be formed by compression moulding SMC. The pultruded frame provides the door with the necessary rigidity.

It is an object of this invention to provide methods of forming a moulded component, for use as say a door, which is hard wearing and which can withstand, inter alia, environmental degradation as well as the strains and stresses placed on the component in use. It is a further object to provide a method which allows a door to be fabricated from a variety of materials so that the shape and bulk characteristics of the component can be controlled. It is a yet further object of the invention to provide a method of forming a door which simplifies prior art methods, specifically those disclosed in our above-identified British patent applications. It is a still further object to provide a door which, once fabricated, may be trimmed to fit into a variety of different sized doorframes.

A first aspect of the invention provides a method of making a moulded component, say a door, the method comprising placing a core comprising at least one slab of foam material into a mould with LPSMC, closing the mould and applying pressure and heat to render the LPSMC fluid to at least partially envelop the core and thereby produce a LPSMC coated component (e.g. a door), wherein the core has at least one cavity which extends across the width thereof and which has at least a portion which is inboard of the intended outer edge of the component, thereby causing the LPSMC to flow into said at least one cavity to form a bridge between the sides of the so-formed component.

There is further provided, in a second aspect of the invention, a moulded component (e.g. a door) comprising a core of foam material at least partially enveloped in a thermoset plastics material formed from LPSMC, the core having at least one cavity, the cavity having at least a portion which is inboard of the outer edge of the component and which extends from one face to the other, the at least one cavity containing thermoset plastics material formed from the LPSMC.

The core may be a single slab of foam material or may formed from two or more distinct slabs of foam material. Where the shaped core is formed from two or more slabs of foam material the cavity may run or extend between, say, two slabs.

Preferably, the or one of the slabs of foam material is fabricated from a structural-density foam material, which is to say a foam material with a density in the range from 250 to 800 kgm⁻³, most preferably with a density of 300 to 400 kgm⁻³, or above.

Where the core is formed from a single slab of foam material, the slab may comprise plural inboard cavities extending through the thickness thereof.

In one embodiment, the core comprises a slab of structural-density foam material and a body of other material, for example a slab of low-density foam material, the cavity being formed therebetween.

In a further embodiment, the core comprises two slabs of structural-density foam material located either side of a body of other material, for example a slab of low-density foam material, cavities being formed between the body and the structural-density slabs.

Preferably, the body is a moulded or otherwise shaped body of low-density foam material having a density of from about 100 to 200 kgm⁻³, most preferably from 150 to 180 kgm⁻³.

Most preferably, one or both of the body and the slab or slabs of structural-density foam material carry lugs or other protuberances to ensure in-mould separation of the body and the or each slab, thereby ensuring the provision of the at least one cavity.

At least one face of the body and/or the or each slab of structural-density foam material may be provided with contours which, subsequent to moulding, are covered with LPSMC to provide contours on at least one face of the so-formed door.

A further aspect of the invention provides a method of making a door, the method comprising placing a core of foam material into a mould LPSMC disposed, closing the mould and applying pressure and heat to render the LPSMC fluid to at least partially envelop the core and thereby produce a LPSMC coated door, wherein the core of foam material has contours to simulate panels, and causing the LPSMC to uniformly cover the contours during moulding.

A fourth aspect of the invention provides a door consisting of a foam core at least partially enveloped by LPSMC compression moulded thereto, the door preferably having contours on at least one face thereof.

In one embodiment, the foam core is a single slab of structural-density foam material.

A fifth aspect of the invention provides a door consisting of a foam core at least partially enveloped by LPSMC compression moulded thereto wherein at least a portion of the foam core has a density in excess of 250 kgm⁻³.

In an embodiment, the foam core comprises a structural density foam slab and a second foam body, the second foam body preferably having a density of from 100 to 200 kgm⁻³, most preferably from 150 to 180 kgm⁻³.

Whilst we do not wish to be limited by any particular theory, we hypothesise that the pressure exerted by the mould during the moulding process controls the rheological properties of the LPSMC. For example, if a complex shape is to be produced, by which is meant a shape with a plurality of bends or changes of direction along or across its' length, a relatively high pressure will be used to ensure that the LPSMC flows evenly over the surface of the core material, providing a surface layer of even thickness. Such high pressures necessitate the use of higher density core materials to prevent collapse thereof during moulding. Preferably, the method includes the step of adjusting the pressure to control the rheological properties of the LPSMC to encapsulate the core.

The mould may be arranged to exert a pressure of 0.1 to 3.04 MPa (1 to 30 bar).

The mould may be raised to a temperature of, say, 90 to 130° C. A temperature of 120±° C. may be normal, although lower and/or higher temperatures may be used, depending on the temperature performance of the core material and the particular resin systems utilised.

Sufficient LPSMC may be placed within the mould such that the core material of the finished product is completely encapsulated.

The core material may be formed in any shape and additionally may be hollow. Suitable core materials are set, closed-cell foams formed from polyurethane or phenolic resins. In certain other applications, other materials such as resin-bonded mineral fibre, metals, wood, plastics materials or ceramics may be used as a core material.

The core material may have apertures formed therein, either blind apertures or ones extending through the core, the LPSMC preferably flowing into such apertures and preferably coating the walls of the core which define those apertures to leave those walls unexposed.

The core may be formed by any convenient means, e.g. moulding, extruding or machining. The core may have reinforcing means such as inserts or fibres distributed there through. Fibres may be homogeneously distributed throughout the foam core material. Suitable fibres would be glass rovings, aramid fibres, hemp, nylon or other plastics materials fibres.

Preferred LPSMCs are those sold by Scott Bader Company Limited of Wellingborough, United Kingdom, under the “Crystic Impreg” brand name. A suitable LPSMC is “Crystic Impreg 6503”, although other LPSMCs such as “Crystic Nupreg H 30” may be used as well as those of other suppliers.

In order that the invention may be more fully understood, it will now be described, by way of example only, with reference to the accompanying figures, in which:

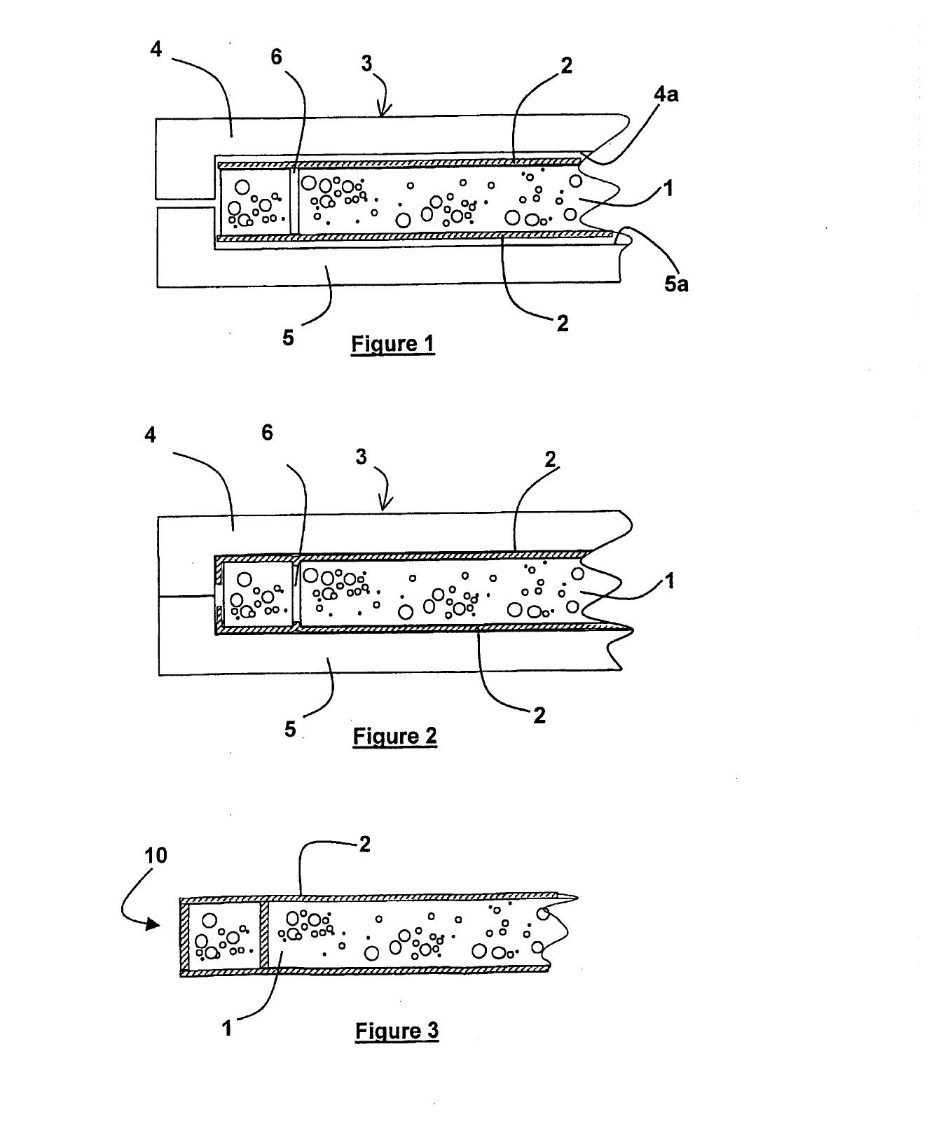

FIG. 1 shows a section through a mould prior to moulding;

FIG. 2 shows a section through the mould of FIG. 1 during moulding;

FIG. 3 shows a section through a product which was moulded in the mould of FIG. 1;

FIG. 4 shows a section through the mould of FIG. 1 with a different core retained therein prior to moulding;

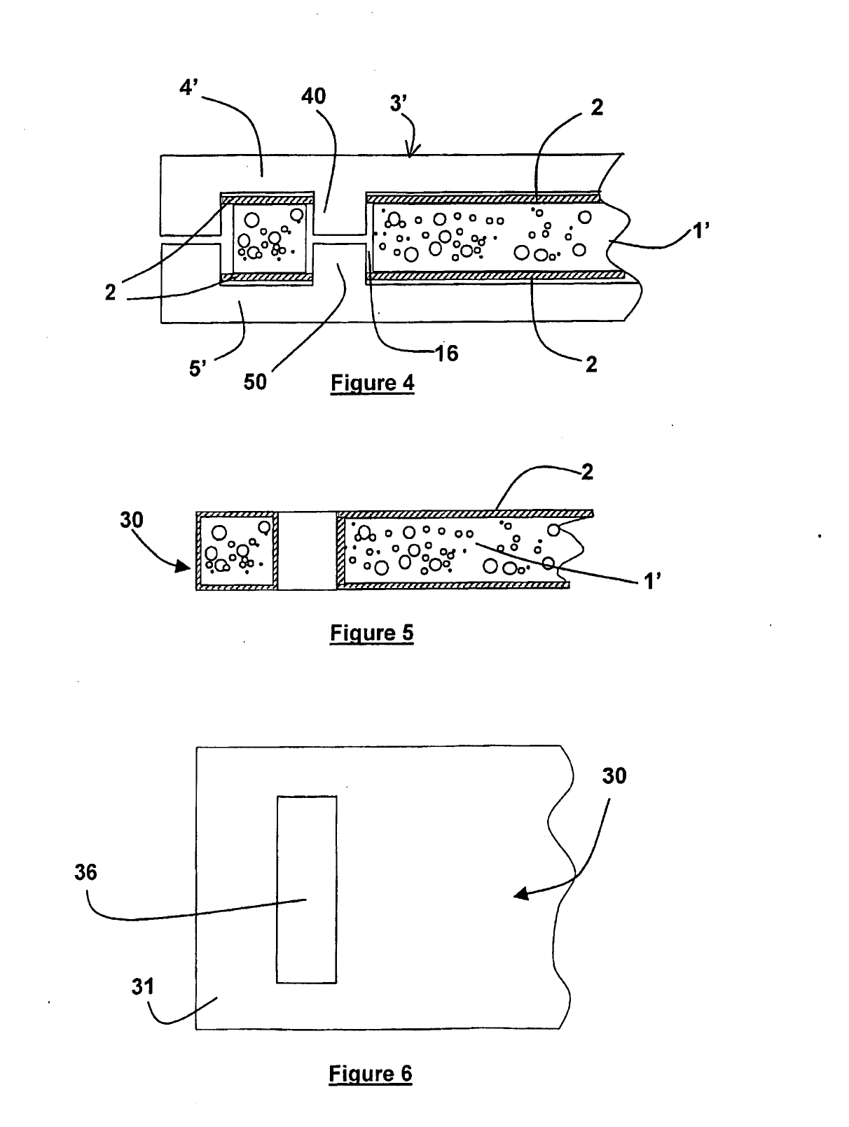

FIG. 5 shows a section through the mould of FIG. 4 during moulding;

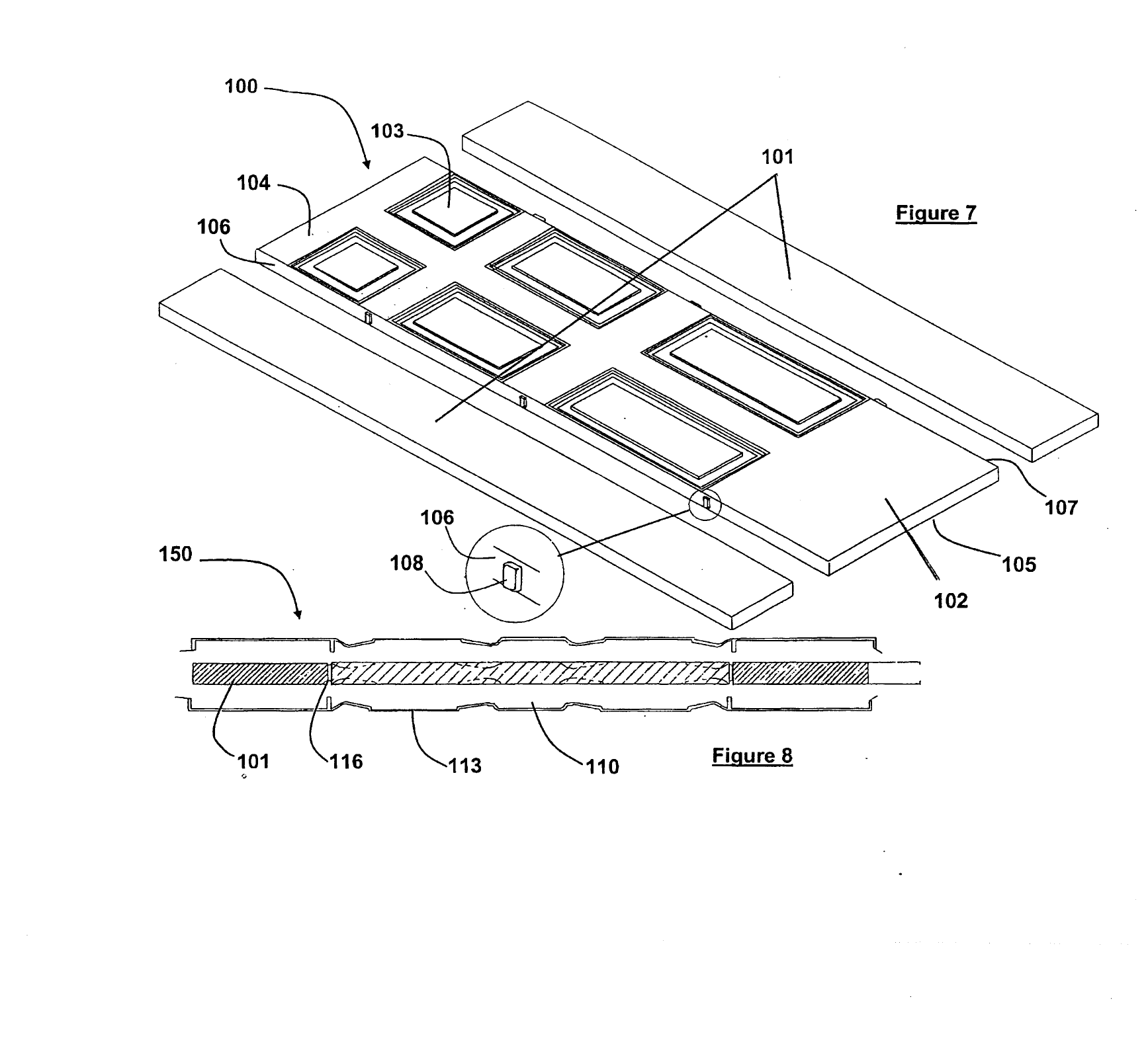

FIG. 6 shows a plan view of a product moulded in the mould of FIG. 4

FIG. 7 shows an exploded perspective view of a three-part core prior to moulding;

FIG. 8 shows an exploded section through a product moulded with the core of FIG. 7;

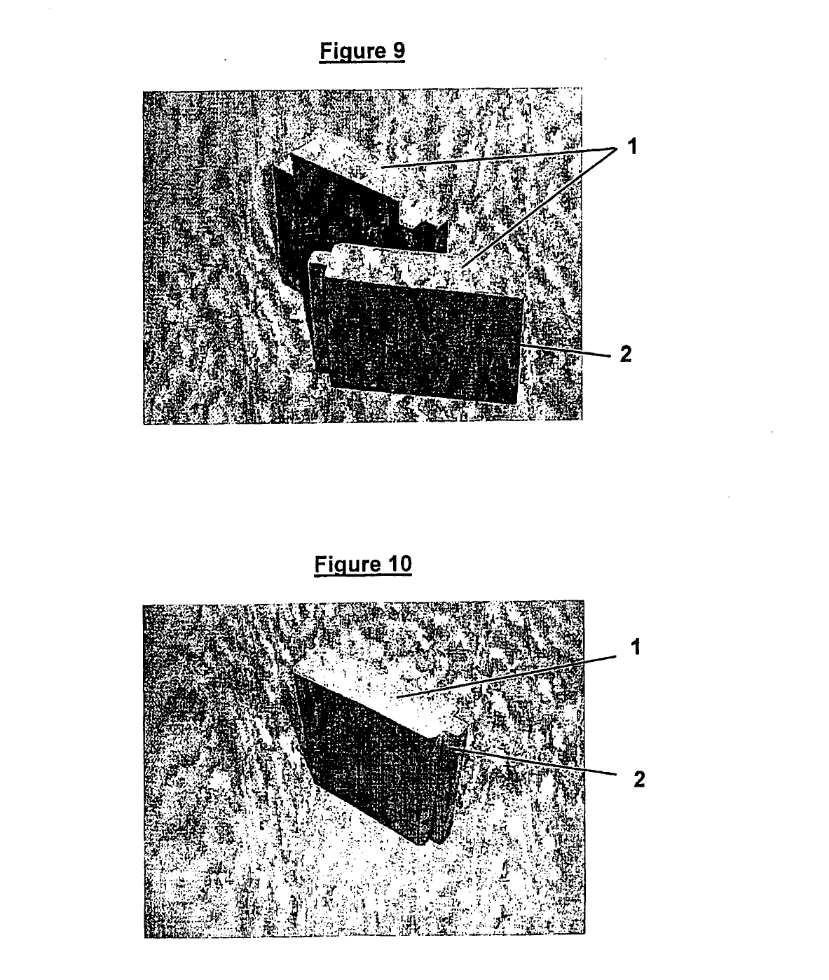

FIG. 9 shows sections through some components made according to the invention; and

FIG. 10 shows a section through a further product made according to the invention.

Referring first to FIG. 1, there is shown a polyurethane foam core material 1 of density 300 kgm⁻³, sandwiched between sheets of LPSMC 2 (Crystic Impreg 6503) located in a mould 3 having rigid upper 4 and lower 5 portions. The upper portion 4 is shown spaced from the lower 5. The core material 1 has a cavity 6 extending through the thickness thereof. The charge of LPSMC 2 is sufficient so that, upon melting and subsequent curing of the LPSMC, the entire outer surface of the core material 1 is covered with LPSMC 2 and the cavity 6 is filled with LPSMC 2. The mould shrinkage of Crystic Impreg 6503, that is the shrinkage of the LPSMC 2 upon cure (subsequent to cross-linking of the resin), is 0.08% as measured by ISO test method 2577. Thus, the foam core 1 is placed slightly under compression upon curing of the LPSMC. The foam core 1 bonds to the LPSMC 2, thereby ensuring that delamination of the LPSMC is avoided.

A gel release layer or in-mould coating (IMC) layer may be coated over the internal surfaces 4a and 5a of the mould parts 4, 5 to prevent adhesion of the LPSMC 2 to the mould 3. In other cases, the LPSMC 2 is self-releasing from the mould. The surfaces 4a and 5a may also have a ‘wood-grain type’ finish to impart the surfaces of the cured LPSMC 2 with a simulated wood grain effect.

The weight and placement of the charge of LPSMC within the mould is closely controlled, To ensure an even depth coating of LPSMC 2 it is necessary to ensure that the weight of charge on either side of the mould is the same. Placement of the charge is also important where an article with a complex shape is required. However, whilst it is important to establish these parameters it is also noted that LPSMCs 2 will self-level, which is to say they will fill any gaps between the mould surfaces 4a, 5a and the core 1.

To mould the LPSMC 2 to the core material 1, the upper and lower portions 4, 5 of the mould 3 are heated to 120° C. and are brought together to exert a pressure of about 1.01 MPa (15 bar) on the LPSMC 2 and core material 1.

As indicated in FIG. 2, the LPSMC 2 becomes fluid under the influence of heat and pressure from the mould 3 and begins to flow around the core material 1, adopting the shape of the core material 1. The reinforcing fibres, which are homogeneously distributed in the LPSMC 2, are carried by the resin in its fluid state to become homogeneously distributed throughout the LPSMC in the “set-state”. After a mould time of about 4 minutes, the temperature of the mould is kept constant to allow the LPSMC to cure, i.e. cross-link.

FIG. 3 shows the subsequently formed product 10 in which the core material 1 has been totally encapsulated by the LPSMC 2. As shown, the LPSMC 2 has flowed into the cavity 6 present in the core material 1, thereby keying the LPSMC 2 to the core material 1. The presence of the filled cavity 6 provides the so-formed component 10 with added structural rigidity and strength. Indeed, a component 10 formed as a door for a building provided with one or more filled cavities 6 will not bend or otherwise distort during or through use.

FIG. 4 shows a further unitary foam core material 1′ held within a mould 3′ having two parts 4′, 5′. Each of the two parts 4′, 5′ has a respective extension portion 40, 50, corresponding to an aperture 16 in the foam core material 1′.

Subsequent to the moulding operation, as shown in FIGS. 5 and 6, a product 30 is produced in which every surface of the core material 1′ is covered with LPSMC 2. The LPSMC 2 covers the exposed surfaces of the aperture 16 to form a covered aperture 36.

When fabricating doors, the aperture 16 may be sized and shaped to receive an item of door furniture, for example a letter box, lock, glazing panel or the like.

As will be appreciated, a lattice of foam core material covered with LPSMC may be formed by using a suitably shaped core material and correspondingly shaped mould.

FIG. 7 shows a three-part foam core 100 for use in fabricating a door, the core comprising two peripheral portions of polyurethane structural-density foam 101, of say 350 kgm⁻³, and a central portion of polyurethane low-density foam 102, say of from about 100 to 200 kgm⁻³ in this case 175 kgm⁻³.

The central portion 102 is shaped, say by moulding to form six panels 103 on both major faces 104, 105. As can be seen from the detail, the edges 106, 107 of the central portion 102 carry lugs 108, which, when the peripheral portions 101 are brought into contact therewith ensure that a cavity 116 is provided between the peripheral portions 101 and the central portion 102.

To form a door, the peripheral portions 101 and central portion 102 are placed in a mould which has portions to correspond with the panels 103 of the central portion 102. The lugs 108 ensure that a cavity 116 is formed between the portions. As stated above, plugs are used to ensure accurate location of the portions 101, 102 within the mould. Sheets of LPSMC are placed within the mould, both above and below the portions 101, 102. The mould is closed and subjected to heat and pressure to mould the LPSMC.

FIG. 8 shows an exploded section through a so-formed door 150, the LPSMC skin being shown away from the core 100 to which it is compression moulded. The cavities 116 have been filled with LPSMC 110 which acts as a structural bridge across the door 150 and thereby provides added structural rigidity and strength.

The cured LPSMC 110 has adopted the contours of the panels to form door panels 113 on either face of the door 150. As above, the mould may have a wood-grain type finish to impart a wood-grain effect to the door 150. Further, the LPSMC 110 can be coloured so that no further work is required to ‘finish’ the door 150.

The panels 113, which need not be in the exact locations indicated in the drawings, may be cut out to receive, for example, glazing panels or other door furniture.

The provision of structural-density peripheral portions 101 and a central portion of lower-density material 102 has several advantages. Firstly, the provision of lugs 108 ensures that a cavity 116 can be formed without the need for pre-machining the foam core material. Secondly, by providing structural-density peripheral portions only, the weight of the door 150 is reduced over what it otherwise would have been. Thirdly, structural-density foams have excellent screw retention characteristics. A screw screwed into a closed-cell, structural-density foam of a density in excess of about 300 kgm⁻³ requires a force in excess of 2 kN (as measured by British Standard BS 6948) to pull it out (that structural-density foam has better pull retention characteristics than soft wood). Thus, hinges, for example, can be screwed directly into the foam material, obviating the need for further reinforcement means, such as metal inserts. Fourthly, the structural-density material can be trimmed such that the so-formed door 150 can be sized to fit a non-conventional aperture, or one size of door may be produced (i.e. the biggest usually requested) and the edges can be trimmed so that the door can be installed in any doorframe. Fifthly, the trimmed or otherwise exposed edges of the door 150 can be machined to receive a lock, for example. Sixthly, due to the lower-density of the central portion 102, it is easier to cut the panels 113 which are formed therein than would be the case if the central portion were fabricated from a structural-density material.

The physical interaction between the LPSMC 110 and core 100 is such that delamination is avoided. There is a mechanical interaction between the foam and the core caused by the slight shrinkage of the LPSMC 110 upon cure and the keying effect of the cavity 116 filled with LPSMC 110. A further mechanical interaction between LPSMC and core can be induced by shot-blasting the foam core prior to moulding. Shot-blasting acts to break the surface layer of the core, thereby exposing the cells at that surface providing a multiplicity of minute keying sites, into which the LPSMC 2 runs during moulding. Other methods rather than shot-blasting may be employed to expose the cells at a surface of the core, say by cutting or abrading the surface.

The core 100 may have a single peripheral structural-density portion 101.

The process characteristics for relatively complex shapes must be carefully controlled to ensure that the LPSMC flows evenly over the core material and that the LPSMC flows at a rate which allows the fibre reinforcements to be carried with the resin. If such controls are not met, the fibres may not be distributed substantially homogeneously throughout the LPSMC coating the so-formed product.

It has been found that it is useful to provide and maintain a constant gap between the core material 1 and the mould 3. If variations in the ‘gap’ distance are exhibited, the LPSMC 2 may ‘pool’ in those areas with a relatively large ‘gap’ distance during moulding. Further, the LPSMC 2 may flow too quickly to ensure that reinforcing fibres are carried homogeneously therewith, thereby causing a non-homogeneous distribution of fibres within the finished product.

By carefully selecting the temperature of, and pressure exerted by the mould 3 the LPSMC 2 will flow evenly around a core material 1 and will produce a product where the LPSMC 2 is well adhered to the core material 1 and where delamination thereof from the core material 1 is not found.

Preferably, the temperature and pressure are selected so that the core material 1 is not structurally affected during the moulding operation. However, in some cases, it has been found that by using a low density polyurethane foam core material, say below 100 kg m⁻³, and exerting a mould pressure of 1.01 MPa, the LPSMC is forced into the body of the core material. The pressure used causes collapse of the foam core material in that region. Such an effect can provide a further “keying” point for the LPSMC sheet 2 to the core. This is evidenced in the Table below where a thicker LPSMC layer appears to be shown for the same charge.

The table below provides examples of the moulding processes and core materials which may be used.

TABLE 1
Details of moulding processes used.

| Core | | Mould | Mould | Mould | | |
|---|---|---|---|---|---|---|
| Material^{a,b} | LPSMC^{c} | T/° C. | P/MPa | Time/s | V_{CM:LPSMC}^{d} | T^{e} LPSMC/mm |
| PU Foam (100) | IMP | 120 | 3.3 | 240 | 4.9 | 3.5 mm |
| PU Foam (300) | IMP | 120 | 3.3 | 240 | 4.9 | 3 mm |
| PU Foam (600) | IMP | 120 | 3.3 | 240 | 4.9 | 3 mm |
| Comp.^{f} | IMP | 120 | 1.5 | 240 | | 3 mm |

^{a}PU is polyurethane
^{b}The density of the core material in kg m⁻³ is found in parenthesis.
^{c}IMP is Crystic Impreg 6503
^{d}V is the dimensionless ratio of the volume of charge of core material to LPSMC.
^{e}T is the thickness of the LPSMC in the finished product
^{f}Comp refers to a core fabricated in accordance with FIG. 7 and the description

FIG. 9 shows a section through two products formed as described above. The polyurethane foam core material 1 has a density of 300 kgm⁻³ and is encapsulated with Crystic Impreg 6503 LPSMC 2. The moulding conditions were those shown in the Table. Inspection of the product showed that the LPSMC 2 was firmly adhered to the core material, with no evidence of weak points.

FIG. 10 shows a section through a product formed by the above-described method. The polyurethane foam core material 1 has a density of 600 kgm⁻³ and is encapsulated with Crystic Impreg 6503 LPSMC 2. The moulding conditions were those shown above. Inspection of the product showed that the LPSMC 2 was firmly adhered to the core material 1, with no evidence of weak points.

A door 150 having a core 100 as shown in FIG. 7 and as described above, was fabricated using the above-identified parameters. The edges were trimmed to leave one edge exposed to which hinges were fixed. The door 150 was installed in a suitably sized doorframe.

Using the method discussed above, many different shaped core materials can be coated with LPSMC. The so-formed components are hard-wearing and resistant to environmental degradation. The reinforcement fibres of the LPSMC provide the product with further resistance to wear. As LPSMC is a thermoset material it sets to form a rigid material. Thus the bend resistance and strength of a core material is improved by external coating with LPSMC.

Any suitable or desired pattern may be formed on the external surface of the LPSMC covered core by providing a negative of the surface on the surfaces of the mould 3, 3′. Thus, the so-formed product may have a textured or otherwise finished surface.

Examples of other products which can be manufactured using the above method are panels for internal and external use, such as cladding panels for buildings, body panels for vehicles, other shaped structural or decorative members.

1-47. (canceled)

48. A method of making a moulded component, the method comprising placing a core comprising at least one slab of foam material into a mould with LPSMC, closing the mould and applying pressure and heat to render the LPSMC fluid to at least partially envelop the core and thereby produce a LPSMC coated component, wherein the core has a length and a width dimension and at least one cavity which extends through or across the width thereof and which has at least a portion which is inboard of an intended outer edge of the component, thereby causing the LPSMC to flow into said at least one cavity to form a bridge between the sides of the so-formed component.

49. A method according to claim 48, comprising exerting a mould pressure of from 0.1 to 3.04 MPa (1 to 30 bar).

50. A method according to claim 48, comprising moulding at a temperature of from 90 to 130° C.

51. A method according to claim 48, comprising placing sufficient LPSMC within the mould to completely encapsulate the core in the so-formed product.

52. A method according to claim 48, comprising using a core formed from a single slab of foam material.

53. A method according to claim 52, comprising forming a plurality of cavities in the core prior to placing the core in the mould.

54. A method according to claim 48, comprising forming the core from two or more distinct slabs of foam material.

55. A method according to claim 54, wherein said at least one cavity extends between two adjacent slabs.

56. A method according claim 48, comprising forming the or at least one of the slabs of foam material from a foam material with a density in the range of from 250 to 800 kgm⁻³.

57. A method according to claim 56, wherein the or said at least one of the slabs of foam material has a density of from 300 to 400 kgm⁻³.

58. A method according to claim 54, comprising forming the core comprising a slab of structural-density foam material and a slab of lower-density foam material, the cavity being formed therebetween.

59. A method according to claim 54, comprising forming the core comprising two slabs of structural-density foam material located either side of a slab of lower-density foam material, cavities being formed between the slab of lower-density foam material and the structural-density slabs.

60. A method according to claim 58, comprising moulding the slab of lower-density foam material.

61. A method according to claim 58, wherein the lower-density foam material has a density of from 100 to 200 kgm⁻³.

62. A method according to claim 54, comprising providing in-mould separation of the slabs by forming lugs or other protuberances on one or both of the facing sides of the slabs to ensure the provision of said at least one cavity.

63. A method according to claim 54, comprising providing the core with contours which, subsequent to moulding, are covered with LPSMC to provide corresponding contours on at least one face of the so-formed component.

64. A moulded component in the form of a door formed by the method of claim 48.

65. A moulded component comprising a core of foam material at least partially enveloped in a thermoset plastics material formed from LPSMC, the core having at least one cavity, the cavity having at least a portion which is inboard of an outer edge of the component and which extends from one face to an other face, the at least one cavity containing thermoset plastics material formed from the LPSMC.

66. A component according to claim 65 wherein the core is completely encapsulated with LPSMC.

67. A component according to claim 65, wherein the core is formed from a single slab of foam material.

68. A component according to claim 65, wherein the core comprises a plurality of cavities.

69. A component according to claim 65, wherein the core comprises two or more distinct slabs of foam material.

70. A component according to claim 69, wherein said at least one cavity extends between two adjacent distinct slabs of foam material.

71. A component according to claim 69, wherein at least one of the slabs of foam material is a foam material with a density in the range from 250 to 800 kgm⁻³.

72. A component according to claim 71, wherein the or each slab of foam material has a density of from 300 to 400 kgm⁻³.

73. A component according to claim 69, wherein the core comprises a slab of structural-density foam material and a slab of lower-density foam material, said at least one cavity being formed therebetween.

74. A component according to claim 69, wherein the core comprises two slabs of structural-density foam material located either side of a slab of lower-density foam material, cavities being formed between the slab of lower-density foam material and the structural-density slabs.

75. A component according to claim 74, wherein the lower-density foam material has a density of from about 100 to 200 kgm⁻³.

76. A component according to claim 69, wherein one or both of the facing sides of the slabs comprises lugs or other protuberances to provide in-mould separation of the slabs and thereby the provision of said at least one cavity.

77. A component according to claim 65, wherein the core has at least one contoured major surface which, subsequent to moulding, is covered with LPSMC to provide corresponding contours on at least one face of the component.

78. A component according to claim 65 shaped as a door.

79. A door consisting of a foam core at least partially enveloped by LPSMC compression moulded thereto, wherein at least a portion of the foam core has a density in excess of 250 kgm⁻³.

80. A door consisting of a foam core at least partially enveloped by LPSMC compression moulded thereto, the door having contours on at least one face thereof.

81. A door according to claim 79, wherein the foam core comprises a structural density foam slab and a second foam body, the second foam body having a density of from 100 to 200 kgm⁻³.

82. A door according to claim 79, wherein the core has a cavity extending through its thickness, the LPSMC filling the cavity.

83. A method of making a door, the method comprising placing a core of foam material into a mould with LPSMC, closing the mould and applying pressure and heat to render the LPSMC fluid to at least partially envelop the core and thereby produce a LPSMC coated door, wherein the core of foam material has contours to simulate panels, and causing the LPSMC to uniformly cover the contours during moulding.

84. A method according to claim 83, comprising exerting a mould pressure of from 0.1 to 3.04 MPa (1 to 30 bar).

85. A method according to claim 83, comprising moulding at a temperature of from 90 to 130° C.

86. A method according to claim 83, comprising placing sufficient LPSMC within the mould to completely encapsulate the core in the so-formed product.

87. A method according to claim 83, comprising using a core formed from a single slab of foam material.

88. A method according to claim 83, comprising forming at least one cavity in the core prior to placing the core in the mould.

89. A method according to claim 83, comprising forming the core from two or more distinct slabs of foam material.

90. A method according to claim 89, wherein a cavity extends between two adjacent slabs.

91. A method according to claim 89, comprising forming at least one of the slabs of foam material from a structural-density foam material, i.e. a foam material with a density in the range from 250 to 800 kgm⁻³.

92. A method according to claim 91, wherein the or each slab of structural density foam material has a density of from 300 to 400 kgm⁻³.

93. method according to claim 91, comprising forming the core comprising two slabs of structural-density foam material located either side of a slab of lower-density foam material, cavities being formed between the slab of lower-density foam material and the structural-density slabs.

94. A method according to claim 88, comprising causing the LPSMC to fill the or each cavity to provide a structural bridge across the door.
